(19) United States
(12) Patent Application Publication
(10) Pub. No.: US 2011/0206840 A1
(43) Pub. Date: Aug. 25, 2011

(54) THERMOSETTING POWDER ADHESIVE COMPOSITION

(76) Inventors: James R. Halladay, Erie, PA (US); Kei-Yi Wei, Erie, PA (US); Kirk J. Abbey, Garner, NC (US)

(21) Appl. No.: 13/127,752

(22) PCT Filed: Nov. 9, 2009
(86) PCT No.: PCT/US09/63712

§ 371 Date: May 5, 2011

Related U.S. Application Data
(60) Provisional application No. 61/112,223, filed on Nov. 7, 2008.
(60) Provisional application No. 61/112,213, filed on Nov. 7, 2008.

(51) Int. Cl. B05D 1/36; C09J 115/02; C09J 171/10; C09J 123/34; C09J 11/04

(52) U.S. Cl. 427/201; 525/329.3; 525/151; 525/215; 524/552

(57) ABSTRACT

A powder adhesive comprising a primary rubber bonding polymer and a thermosetting component, and a method for bonding elastomers to metals employing the same. By adding a thermosetting component to a powdered adhesive, the adhesive may be applied to a substrate, sintered and thermoset to provide a sweep resistant adhesive film on the substrate, which may subsequently be bonded to an elastomer. Without a thermosetting component, the adhesive is at risk to re-melt or otherwise soften during a heated elastomer molding operation which in turn could cause the adhesive material to sweep off the substrate.

### CROSS-REFERENCE TO RELATED APPLICATIONS

The present application claims priority under 35 U.S.C. §119(e) from U.S. Provisional Patent Application Ser. No. 61/112,213, filed Nov. 7, 2008, entitled “THERMOSETTING POWDER ADHESIVE COMPOSITION”, and U.S. Provisional Patent Application Ser. No. 61/112,223, filed Nov. 7, 2008, entitled “STABLE POWDER ADHESIVE”, the disclosures of which are incorporated herein by reference.

### FIELD OF THE INVENTION

The present invention relates to powder adhesive compositions particularly useful for bonding rubber to metal. More particularly, the present invention relates to powdered adhesives which form thermoset films upon heating to bond vulcanizable elastomers to metallic substrates.

### BACKGROUND OF THE INVENTION

Rubber-to-metal adhesion is necessary in order to make many of the rubber products we rely upon today including tires, mounts, bushings and some types of seals. Historically, this has been accomplished through making the rubber compounds self-bonding to brass plated steel or through the use of solvent or aqueous based primers with solvent or aqueous based adhesive covercoats.

Powder rubber to substrate adhesives have recently been developed as discussed in U.S. patent application Ser. No. 12/126,175, filed May 23, 2008, entitled “POWDER ADHESIVES FOR BONDING ELASTOMERS”, herein incorporated by reference in full. While these are environmentally preferred to solvent or aqueous adhesives, they suffer from some problems not encountered with the prior technologies. Specifically, powder adhesives are more prone to “sweep” when an elastomer is injected into a mold cavity containing a powder coated part. The incoming rubber sweeps the powder adhesive from the part, even if the powder adhesive has been sintered prior to molding.

Bonding of rubber vulcanizates to substrates, especially metal is conventionally obtained by two-coat primer-overcoat adhesive systems or one-coat primerless systems. Adhesive composition must exhibit excellent bonding, demonstrated as retention of rubber on the substrate after bond destruction. Further, when employed in a rubber molding operation, the adhesive must exhibit good sweep resistance. Sweep resistance is regarded as the ability of the uncured adhesive coating on the substrate to remain undisturbed against the force of injected green rubber into the mold cavity.

Sweep resistance is particularly difficult to achieve when a powder adhesive is employed. The sweep resistance of a powder adhesive is improved somewhat by heating the coated part to sinter the powder adhesive prior to the molding operation. However, a sintered powder adhesive still often lacks the level of sweep resistance required for many rubber molding/bonding operations. During the heated molding/bonding operation, the sintered adhesive could melt and is therefore prone to sweep as liquid rubber enters the mold.

It would therefore be desirable to provide a powder adhesive that possesses adequate sweep resistance for rubber molding/bonding operations.

### SUMMARY OF THE INVENTION

In a first aspect of the present invention, a powder adhesive is provided comprising a primary rubber bonding polymer and a thermosetting component. By adding a thermosetting component to a powdered adhesive, the adhesive may be applied to a substrate, sintered and thermoset to provide a sweep resistant adhesive film on the substrate, which may subsequently be bonded to an elastomer. Without a thermosetting component, the adhesive is at risk to re-melt or otherwise soften during a heated elastomer molding operation which in turn could cause the adhesive material to sweep off the substrate.

Thus, an adhesive for bonding metal to elastomers is provided which does not employ solvents and as such is delivered to a substrate substantially free of water or other liquids, while maintaining sweep resistance and forming environmentally durable bonds. Further, the powder adhesive compositions of the present invention comprise materials which are shelf stable and do not sinter nor alter their bonding properties during storage, yet can flow sufficiently to be sprayable and are sinterable at higher temperatures.

One advantage of powdered (dry) adhesives is the ability to mix materials that are incompatible in solvent or aqueous forms. Powder technology allows mixtures of otherwise incompatible materials to be partitioned from each other as separate powders and the different powders can be mixed together in dry blends. They remain compatible and/or non-reactive until the composition is heated at which time the components melt and merge together.

Using this technique, the embodiments of the present invention provide mixtures of powder adhesives containing a thermosetting component which remains unreactive until the powder adhesive is sintered, and the thermosetting component reacts to form a thermoset film and adhere the adhesive to a substrate so as to render the thermoset adhesive sweep resistant and stable.

In a first aspect of the present invention, a powder adhesive composition comprising a sinterable primary rubber bonding polymer and a thermosetting compound, wherein upon heating the primary rubber bonding polymer will be stabilized in a thermoset film and wherein the thermosetting compound comprises either: (1) a cure agent which will at least partially cure the primary rubber bonding polymer to form said thermoset film; or, (2) a separate thermosetting composition which will entrap the primary rubber bonding polymer in said thermoset film.

In one embodiment of the present invention, the rubber bonding polymer comprises a sinterable dichlorobutadiene alpha-bromoacrylonitrile copolymer powder. In a further embodiment of the present invention, the cure agent comprises at least one of an organic peroxide, a thiourea, or a sulfur curative. In a still further embodiment of the present invention, the thermosetting compound comprises a phenolic resin and phenolic curative. An in yet another embodiment of the present invention, the cure system comprises from 0.5% to 15% of the composition and is capable of crosslinking the sinterable primary rubber bonding polymer.

In another embodiment of the present invention, the separate thermosetting composition comprises chlorosulfonated polyethylene and a crosslinker capable of crosslinking the chlorosulfonated polyethylene. In a preferred embodiment of the present invention, the crosslinker comprises poly-dinitrosobenzene. In a most preferred embodiment of the present invention, the composition comprises 1 to 25 weight percent chlorosulfonated polyethylene, and 1 to 25 weight percent poly-dinitrosobenzene.

In an additional embodiment of the present invention, the adhesive composition further comprises from 1 to 30 weight percent of a filler, and preferably the filler comprises carbon black.

In another aspect of the present invention, a method for reducing sweep in a powder adhesive is provided comprising, (a) providing a sinterable primary rubber bonding polymer, (b) providing a thermosetting compound, (c) mixing the rubber bonding polymer and thermosetting compound together in powder form to provide a powder adhesive composition, (d) applying the powder adhesive composition to a substrate to at least partially coat the substrate with powder adhesive, and (e) heating the coated substrate to sinter and thermoset the powder adhesive composition.

In another embodiment of the present invention, the thermosetting compound comprises either (1) a cure agent which will at least partially cure the primary rubber bonding polymer, or (2) a separate thermosetting composition which will entrap the primary rubber bonding polymer in a thermoset film.

In yet another embodiment of the present invention, the primary rubber bonding polymer comprises a sinterable dichlorobutadiene alpha-bromoacrylonitrile copolymer powder, and the cure agent comprises at least one of an organic peroxide, a thiourea, or a sulfur curative.

### DETAILED DESCRIPTION OF THE INVENTION

In one embodiment of the present invention, the powder adhesive comprises a sinterable primary rubber bonding polymer powder. To this powder adhesive composition a thermosetting compound is added comprising (1) a cure agent which will at least partially cure the primary rubber bonding polymer, or (2) a separate thermosetting composition which entraps the rubber bonding polymer in a thermoset film.

In another embodiment of the present invention, the sinterable primary rubber bonding polymer comprises a halogen-containing polyolefin. The halogens employed in the halogenated polyolefinic elastomers will usually be chlorine or bromine, although fluorine can also be used. Mixed halogens can also be employed in which case the halogen-containing polyolefinic elastomer will have more than one halogen substituted thereon. Halogen-containing polyolefinic elastomers and their preparation are well-known in the art and no need is seen to elucidate in any detail on these materials or their manufacture.

Representative halogenated polyolefins include chlorinated natural rubber, chlorine- and bromine-containing synthetic rubbers including polychloroprene, chlorinated polychloroprene, chlorinated polybutadiene, hexachloropentadiene, butadiene/halogenated cyclic conjugated diene adducts, chlorinated butadiene styrene copolymers, chlorinated ethylene propylene copolymers and ethylene/propylene/non-conjugated diene terpolymers, chlorinated polyethylene, chlorosulfonated polyethylene, poly(2,3-dichloro-1,3-butadiene), brominated poly(2,3-dichloro-1,3-butadiene), copolymers of α-haloacrylonitriles and 2,3-dichloro-1,3-butadiene, chlorinated poly(vinyl chloride) and the like including mixtures of such halogen-containing elastomers.

The butadiene monomers useful for preparing the butadiene polymer can essentially be any monomer containing conjugated unsaturation. Typical monomers include 2,3-dichloro-1,3-butadiene; 1,3-butadiene; 2,3-dibromo-1,3-butadiene isoprene; isoprene; 2,3-dimethylbutadiene; chloroprene; bromoprene; 2,3-dibromo-1,3-butadiene; 1,1,2-trichlorobutadiene; cyanoprene; hexachlorobutadiene; and combinations thereof. It is particularly preferred to use 2,3-dichloro-1,3-butadiene since a polymer that contains as its major portion 2,3-dichloro-1,3-butadiene monomer units has been found to be particularly useful in adhesive applications due to the excellent bonding ability and barrier properties of the 2,3-dichloro-1,3-butadiene-based polymers. As described above, an especially preferred embodiment of the present invention is one wherein the butadiene polymer includes at least 60 weight percent, preferably at least 70 weight percent, 2,3-dichloro-1,3-butadiene monomer units.

The butadiene monomer can be copolymerized with other monomers. Such copolymerizable monomers include α-haloacrylonitriles such as α-bromoacrylonitrile and α-chloroacrylonitrile; α,β-unsaturated carboxylic acids such as acrylic, methacrylic, 2-ethylacrylic, 2-propylacrylic, 2-butylacrylic and itaconic acids; alkyl-2-haloacrylates such as ethyl-2-chloroacrylate and ethyl-2-bromoacrylate; α-bromovinylketone; vinylidene chloride; vinyl toluenes; vinylnaphthalenes; vinyl ethers, esters and ketones such as methyl vinyl ether, vinyl acetate and methyl vinyl ketone; esters amides, and nitriles of acrylic and methacrylic acids such as ethyl acrylate, methyl methacrylate, glycidyl acrylate, methacrylamide and acrylonitrile; and combinations of such monomers. The copolymerizable monomers, if utilized, are preferably α-haloacrylonitrile and/or α, β-unsaturated carboxylic acids. The copolymerizable monomers may be utilized in an amount of 0.1 to 30 weight percent, based on the weight of the total monomers utilized to form the butadiene polymer.

In a preferred embodiment of the present invention, the rubber bonding polymer comprises a copolymer of dichlorobutadiene and brominated acrylonitrile (DCD/α-BrAN). Copolymer of DCD/α-BrAN are known to be effective for bonding rubber to metal in the range of 95:5 to 85:15. However, used alone DCD/α-BrAN is prone to sweep because no reaction occurs during the sintering process to make it thermosetting. The addition of another thermosetting component such as a powdered phenolic composition or a material (either melting or non-melting) containing a curing or crosslinking agent can be dry blended with the powdered DCD/α-BrAN to render it thermosetting during the sintering process and keep it from sweeping off of the metal.

In one embodiment of the present invention, the thermosetting component comprises a curing agent added to the rubber bonding polymer to at least partially cure and thermoset the rubber bonding polymer. In a preferred embodiment of the present invention, wherein rubber bonding polymer comprises a DCD/α-BrAN copolymer and the curing agent comprises at least one of an organic peroxide, a thiourea, or a sulfur cure system such as tetramethylthiuram disulfide. The curing agent at least partially cures and thermosets the DCD/α-BrAN during the powder sintering process to improve sweep resistance of the adhesive.

In a most preferred embodiment of the present invention, the curing agent comprises at least one of the following: organic peroxides (generally di-tertiary alkyl peroxides) including but not limited to 2,5-dimethyl-2,5-di(t-butylperoxy) hexane, 2,5-dimethyl-2,5-di(t-butylperoxy) hexyne-3, dicumyl peroxide, t-butyl cumyl peroxide and α,α′-di(2-t-butylperoxyisopropyl) benzene; thioureas including but not limited to 1,3-dibutylthiourea, trimethylthiourea, 1,3-diethylthiourea, and ethylenethiourea; and, sulfur donors including but not limited to tetramethylthiuram disulfide, tetraethylthiuram disulfide, dipentamethylenethiuram tetrasulfide or hexasulfide, or elemental sulfur combined with traditional sulfur accelerators known to the rubber industry.

In another embodiment of the present invention, the primary rubber bonding polymer is not provided with a cure agent, but rather a separate thermosetting composition is added to the primary rubber bonding polymer to provide a thermosetting film upon cure which entraps and stabilizes the primary rubber bonding polymer in a thermoset film. The thermosetting composition is preferably compatible with the primary adhesive constituents so as to provide good mixing and adhesive film formation. Further, the thermosetting composition is preferably absent internal or pendant unsaturation so as to prevent curing while the components are mixed in powdered form. In a preferred embodiment of the present invention, the cure is not initiated until the mixture is heated during a sintering step.

In a further embodiment of the present invention, a rubber bonding polymer such as a halogenated polybutadiene is employed as the primary rubber bonding polymer, and a second thermosetting composition comprising chlorosulfonated polyethylene and a curative such as poly-dinitrosobenzene (DNB) are provided to affect a thermoset film upon heating. The chlorosulfonated polyethylene and DNB will react to form a thermoset film which entraps and stabilized the primary rubber bonding polymer. Additionally, since chlorosulfonated polyethylene and DNB are preferred rubber adhesive components, they are particularly well suited for use in the present invention. The addition of a minor percentage of chlorosulfonated polyethylene into a polybutadiene based formulation along with DNB makes the composition thermosetting. In addition to chlorosulfonated polyethylene, other thermosetting polymer compounds suitable for use in the present invention include polychloroprene and chlorinated polyethylene.

In another aspect of the invention, it has also been discovered that addition of particular reinforcing fillers to the rubber bonding polymer improves its sweep resistance. A reinforcing filler increases the viscosity, which improves sweep resistance and it also reinforces the polymer, thus improving the strength, especially at high temperatures.

In a preferred embodiment of the present invention, the reinforcing filler comprises a nano-scale particulate reinforcing filler such as carbon black, precipitated or fumed silicas, fumed metal oxides such as zinc oxide, or silicates such as calcium silicate. These materials increase the strength of vulcanized rubber compounds and are shown here to be useful in increasing the hot tear strength of the adhesive composition. In an embodiment of the present invention, the filler is present in an amount from 1 to 30 weight percent. Other suitable fillers comprise particulate fillers that have a primarily particle size of less than about 200 nanometers.

It is also to be understood that the phraseology and terminology herein are for the purposes of description and should not be regarded as limiting in any respect. Those skilled in the art will appreciate the concepts upon which this disclosure is based and that it may readily be utilized as the basis for designating other structures, methods and systems for carrying out the several purposes of this development. It is important that the claims be regarded as including such equivalent constructions insofar as they do not depart from the spirit and scope of the present invention.

Although the present invention has been described with reference to particular embodiments, it should be recognized that these embodiments are merely illustrative of the principles of the present invention. Those of ordinary skill in the art will appreciate that the compositions, apparatus and methods of the present invention may be constructed and implemented in other ways and embodiments. Accordingly, the description herein should not be read as limiting the present invention, as other embodiments also fall within the scope of the present invention as defined by the appended claims.

### EXAMPLES

Covercoat A is adhesive topcoat composition containing poly-dinitrosobenzene (DNB) and other fillers in post-brominated polydichlorobutadiene. When dried and ground Covercoat A is non-sintering and therefore does not withstand sweep when employed in a mold as a powdered adhesive composition.

Primer A is a thermosetting blend of acrylonitrile butadiene rubber with phenolic resins and curatives for the phenolic resins. The curatives are methylene donors, in this case, a blend of hexamethylenetetramine (HMT) and hexamethoxymethylmelamine (HMMM).

The topcoat compositions in Examples 1 to 3 were bonded to zinc phosphatized steel (ZPS) coupons. Powder Primer A was applied and sintered 5 minutes at 320° F. The topcoat was sintered 7 minutes at 320° F. A sulfur-cured carbon-black reinforced natural rubber compound (HC130) was bonded in an injection mold at 300° F.

### Examples 1 to 3 of Dry-Blended Powders

| | Example (dry blends) | | |
|---|---|---|---|
| | Control 1 | Dry blend 2 | Dry blend 3 |
| DCD/α-BrAN | 100.0 | 75.0 | 80.0 |
| Primer A | — | 25.0 | — |
| Covercoat A | — | — | 20.0 |
| Primer Thickness | 2.6 | 1.9 | 1.9 |
| Total Film Thickness (mils) | 3.0 | 2.8 | 3.1 |
| Sweep | Significant | None | None |
| Hot Tear | Fair | Fair | Good |
| Primary Bond (pounds) | 49 | 52 | 59 |
| Boiling Water resistance | <9 min. | >4 hrs | >24 hrs |

### Examples 4 to 6 of Dry-Blended Powders

In another example, a chlorinated polypropylene (CPP) topcoat containing 10% DNB was blended with a dichlorobutadiene-alpha-bromoacrylonitrile-hydroxyethylacrylate (DCD/α-BrAN-HEA) terpolymer (90:8:2) to make a topcoat with better performance than either material separately.

Examples 4 to 6 were bonded to zinc phosphatized steel (ZPS) coupons. Powder Primer A was applied and sintered 5 minutes at 320° F. The topcoat was sintered 7 minutes at 320° F. A sulfur-cured carbon-black reinforced natural rubber compound (HC130) was bonded in an injection mold at 300° F.

| | Example (dry blends) | | |
|---|---|---|---|
| | Control 4 | Control 5 | Dry blend 6 |
| DCD/α-BrAN-HEA | 100.0 | — | 50.0 |
| CPP composition | — | 100.0 | 50.0 |
| Film formation | Excellent | Poor | Good |
| Sweep | Significant | None | None |
| Hot Tear | Fair | Good | Good |
| Primary Bond (pounds) | 66 | 58 | 63 |
| Boiling Water resistance | >4 hrs | <2 min. | >16 hrs |

### Examples 7 to 11 of Dry-Blended Powders

The different powders can be blended across a fairly broad range as demonstrated by the topcoats in Examples 7-11. At higher levels of phenolic primer, the blend can be used as a single coat system rather than the traditional two coat primer/adhesive systems.

Example (dry blends)

| | 7 | 8 | 9 | 10 | 11 |
|---|---|---|---|---|---|
| DCD/α-BrAN | 75.0 | 65.0 | 55.0 | 45.0 | 35.0 |
| Primer A | 25.0 | 35.0 | 45.0 | 55.0 | 65.0 |

The following data was generated with zinc phosphatized steel (ZPS) coupons. Powder Primer A was applied and sintered 5 minutes at 320° F. The topcoat was sintered 7 minutes at 320° F. A sulfur-cured carbon-black reinforced natural rubber compound (HC130) was bonded in an injection mold at 300° F.

| | Example (dry blends) | | | | |
|---|---|---|---|---|---|
| | 7 | 8 | 9 | 10 | 11 |
| Total Film Thickness (mils) | 2.4 | 2.9 | 2.7 | 3.3 | 3.6 |
| Primary Bond (pounds) | 52 | 52 | 49 | 44 | 30 |

The following was bonded to zinc phosphatized steel (ZPS) coupons without the use of a primer. The topcoat was sintered 7 minutes at 320° F. A sulfur-cured carbon-black reinforced natural rubber compound (HC130) was bonded in an injection mold at 300° F.

| | Example (dry blends) | | | | |
|---|---|---|---|---|---|
| | 7 | 8 | 9 | 10 | 11 |
| Total Film Thickness (mils) | 1.2 | 1.3 | 1.8 | 2.3 | 2.2 |
| Primary Bond (pounds) | 31 | 40 | 49 | 46 | 27 |

In Examples 13-17 the addition of both a curative for the rubber bonding polymer and a carbon black filler (example 17) provide superior performance over compositions containing only filler (13) or only a curative (14-16).

| | 12 | 13 | 14 | 15 | 16 | 17 |
|---|---|---|---|---|---|---|
| DCD/α-BrAN | 100.0 | 85.0 | 95.0 | 97.0 | 95.0 | 80.0 |
| N234 carbon black | — | 15.0 | — | — | — | 15.0 |
| DBPH* | — | — | 5.0 | — | — | 5.0 |
| DBTU* | — | — | — | 3.0 | — | — |
| TMTD* | — | — | — | — | 5.0 | — |

MDR 2000 rheometer tested 15 minutes at 320° F.

| | | | | | | |
|---|---|---|---|---|---|---|
| Low torque (lb-in) | 0.06 | 0.39 | 0.08 | 0.11 | 0.03 | 0.28 |
| High torque (lb-in) | 0.26 | 0.70 | 8.04 | 3.90 | 3.89 | 23.94 |
| Primary bond strength (lbs) | 71 | 70 | 61 | 65 | 60 | 77 |
| Boiling water resistance | >4 hrs | >4 hrs | >4 hrs | >4 hrs | >4 hrs | >24 hrs |
| Hot Tear resistance | poor | fair | fair | fair | fair | excellent |
| % rubber tear | 0 | 5 | 5 | 5 | 5 | 80 |
| Sweep resistance | poor | fair | good | good | good | no sweep |

*DBPH: 50% active 2,5-dimethyl-2,5-di(t-butylperoxy) hexane
*DBTU: 1,3-dibutylthiourea
*TMTD: tetramethylthiuram disulfide

Similarly, in Examples 18-22 secondary thermosetting components (DNB and CSPE), are provided in place of a curative for the primary rubber bonding polymer (DCD/α-BrAN).

| | 18 | 19 | 20 | 21 | 22 |
|---|---|---|---|---|---|
| DCD/α-BrAN | 100.0 | 90.0 | 85.0 | 60.0 | 65.0 |
| DNB | — | 10.0 | — | 10.0 | 10.0 |
| Carbon Black | — | — | 15.0 | 15.0 | — |
| Chlorosulfonated | — | — | — | 15.0 | 15.0 |
| polyethylene | | | | | |
| SiO₂ (powder) | — | — | — | — | 10.0 |

MDR 2000 rheometer tested 15 minutes at 320° F.

| | | | | | |
|---|---|---|---|---|---|
| Low torque (lb-in) | 0.06 | 0.03 | 0.39 | 0.76 | 0.28 |
| High torque (lb-in) | 0.26 | 0.62 | 0.70 | 16.73 | 7.16 |
| Hot Tear resistance | poor | poor | fair | Excellent | Excellent |
| % rubber tear | 0 | 0 | 5 | rubber break | rubber break |
| Sweep resistance | poor | poor | fair | no sweep | no sweep |

What is claimed is:

1. A powder adhesive composition comprising a sinterable primary rubber bonding polymer and a thermosetting compound, wherein upon heating the primary rubber bonding polymer will be stabilized in a thermoset film and wherein the thermosetting compound comprises either:
(1) a cure agent which will at least partially cure the primary rubber bonding polymer to form said thermoset film; or, (2) a separate thermosetting composition which will entrap the primary rubber bonding polymer in said thermoset film.

2. The adhesive composition of claim 1, wherein the rubber bonding polymer comprises a sinterable dichlorobutadiene alpha-bromoacrylonitrile copolymer powder.

3. The adhesive composition of claim 2, wherein the cure agent comprises at least one of an organic peroxide, a thiourea, or a sulfur curative.

4. The adhesive composition of claim 1, wherein the thermosetting compound comprises a phenolic resin and phenolic curative.

5. The adhesive composition of claim 1, wherein the cure system comprises from 0.5% to 15% of the composition and is capable of crosslinking the sinterable primary rubber bonding polymer.

6. The adhesive composition of claim 1, wherein the separate thermosetting composition comprises chlorosulfonated polyethylene and a crosslinker capable of crosslinking the chlorosulfonated polyethylene.

7. The adhesive composition of claim 6, wherein the crosslinker comprises poly-dinitrosobenzene.

8. The adhesive composition of claim 6, comprising 1 to 25 weight percent chlorosulfonated polyethylene.

9. The adhesive composition of claim 7, comprising 1 to 25 weight percent poly-dinitrosobenzene.

10. The adhesive composition of claim 1, further comprising from 1 to 30 weight percent of a filler.

11. The adhesive composition of claim 10, wherein the filler comprises carbon black.

12. A method for reducing sweep in a powder adhesive comprising:
(a) providing a sinterable primary rubber bonding polymer;
(b) providing a thermosetting compound;
(c) mixing the rubber bonding polymer and thermosetting compound together in powder form to provide a powder adhesive composition;
(d) applying the powder adhesive composition to a substrate to at least partially coat the substrate with powder adhesive; and,
(e) heating the coated substrate to sinter and thermoset the powder adhesive composition.

13. The method of claim 12, wherein the thermosetting compound comprises either:
(1) a cure agent which will at least partially cure the primary rubber bonding polymer; or, (2) a separate thermosetting composition which will entrap the primary rubber bonding polymer in a thermoset film.

14. The method of claim 12, wherein the primary rubber bonding polymer comprises a sinterable dichlorobutadiene alpha-bromoacrylonitrile copolymer powder.

15. The method of claim 13, wherein the cure agent comprises at least one of an organic peroxide, a thiourea, or a sulfur curative.
